(19) United States
(12) Patent Application Publication
(10) Pub. No.: US 2025/0269557 A1
(43) Pub. Date: Aug. 28, 2025

(54) DEVICE FOR PRODUCING MOLDED CONCRETE BLOCKS, AND METHOD FOR PRODUCING MOLDED CONCRETE BLOCKS

(71) Applicant: KOBRA Formen GmbH, Lengenfeld (DE)

(72) Inventors: Holger STICHEL, Lengenfeld-OT Pechtelsgrün (DE); Jonas JACOB, Wildenau (DE)

(73) Assignee: KOBRA Formen GmbH, Lengenfeld (DE)

(21) Appl. No.: 18/858,467

(22) PCT Filed: Apr. 24, 2023
(86) PCT No.: PCT/EP2023/060685

§ 371 Date: Oct. 21, 2024

(30) Foreign Application Priority Data
Apr. 25, 2022 (DE) 10 2022 109 855.9

(51) Int. Cl. B28B 7/00; B28B 3/02; B28B 7/38; B28B 7/44; B28B 7/46; B28B 11/08; B28B 13/06

(52) U.S. Cl. CPC B28B 7/0097; B28B 3/022; B28B 7/388; B28B 7/44; B28B 7/46; B28B 11/0872; B28B 13/065

(57) ABSTRACT

A device for producing molded concrete blocks includes a mold lower part in which at least one mold cavity is formed and a mold upper part including at least one pressure piece with a lower face facing the mold cavity, an upper face facing away from the mold cavity, and lateral surfaces, wherein the pressure piece has fluid openings on the lower face and/or on the lateral surfaces and is designed to engage into the mold cavity such that when the pressure piece is engaged, a fluid can be introduced into the mold cavity from the fluid openings and/or when the pressure piece is engaged, a fluid can be discharged out of the mold cavity from the fluid openings.

The invention relates to an apparatus having an upper mold part and a lower mold part, for the production of molded concrete blocks, and a method for the production of molded concrete blocks.

An apparatus for the production of molded concrete blocks comprises a lower mold part and an upper mold part. The lower mold part is open at the top and at the bottom, wherein the underside is closed off by means of a horizontal base surface. The lower mold part comprises one or more mold cavities, into which the concrete mixture is filled. The upper mold part has a punch unit for compacting the concrete mixture in the mold cavities. The punch unit comprises pressure pieces that can engage into the mold cavities of the lower mold part. Pressure pieces are also referred to as pressure plates. By means of the apparatus, the concrete mixture is compacted by the pressure pieces that engage, so as to form one or more molded concrete blocks.

The pressure pieces used during production serve as punch plates, so as to form the surface of the molded concrete blocks. Conventionally, the pressure piece is a piece of sheet metal that has been cut to the proper dimensions. The surface mirror of the pressure piece, which rests on the concrete mixture, can be milled and can be configured to be smooth, for example, or to have three-dimensional contours or embossings.

In block production, the concrete mixture is filled into the upper openings of the mold cavities, and subsequently pressed by means of the pressure pieces, in that these are lowered into the mold cavities by means of a top-load unit, through the upper openings. By shaking the support base, compaction of the concrete mixture takes place, to produce molded concrete blocks that are stable in shape. The molded concrete blocks are then unmolded through the lower openings of the mold cavities, and the pressure plates are lifted off.

A typical process sequence for molding molded concrete blocks from a layered concrete mixture comprises filling the mold by means of a first filling carriage. The concrete mixture is pre-compacted by lowering the pressure piece into it. Then the top load is raised with the pressure pieces, so as to allow the mold to be filled by means of the second filling wagon. Layering of the concrete mixture forms a two-layer molded concrete block having a core concrete and a decorative concrete applied to it. After filling, main compaction of the layered concrete mixture takes place. During this process, the pressure piece dips into the mold cavity, and the concrete mixture is compacted by means of the pressure from above and the shock vibration. Compaction takes place until the concrete mixture has collapsed to the desired, product-dependent block height. Subsequently, the mold is raised for unmolding the block layer, while the pressure piece is still resting on the block surface. Then the pressure piece is lifted up off the block. During the production process described as an example, the properties of the unmolded block are determined by way of the concrete mixture that is filled in and by the compaction process.

Problems during production can be caused by the pressure piece adhering to the compacted concrete mixture by suction during unmolding. When the pressure piece is lifted off the block surface, damage to the block surface can occur due to a partial vacuum, in that regions of the surface are torn away along with the pressure piece that lifts off. The risk of surface damage can be reduced by means of slowly raising the pressure piece, which reduces the partial vacuum, on the one hand, but also reduces the production speed, on the other hand.

Furthermore, in the production process described above, the possibilities of adjusting special properties of the blocks, for example color, color progression, chemical properties, by way of the filling process, or actually varying them during the production process, are restricted, since the same blocks are produced during every production cycle. The moisture values of the decorative concrete are also limited to a narrow range, since excess water cannot escape from the mold cavity and from the block surface.

CN 1 13 547 612 A shows a method and an apparatus for the production of bricks. In brick production, materials are distributed into a mold cavity, so as to form a pre-form, a pressing head is pressed down in the mold cavity so as to compact and press the pre-form, and water is pumped away.

DE 10 2007 030 324 A1 shows an apparatus for the production of cement products, in particular tiles, comprising a mold and a press-down mechanism having a pressing head as well as water removal devices in the pressing head.

EP 1 281 494 A2 shows an apparatus for pressing powder, as used for the production of ceramic tiles. By means of a punch, the surface of which has porous material, air can be removed from the powder during compaction.

E 88 09 498 U1 shows an apparatus for the production of a concrete layer. The pressing plate is made of elastically deformable material, so as to facilitate its release.

The task arises of indicating an improved apparatus and an improved method for solving the above problems.

To accomplish this task, an apparatus is provided for the production of molded concrete blocks. It comprises a lower mold part in which at least one mold cavity is formed, and an upper mold part comprising at least one pressure piece having an underside that faces the mold cavity and a top side that faces away from the mold cavity, as well as side surfaces. The pressure piece can be lowered in such a manner that it engages into the mold cavity. The pressure piece has a plurality of fluid openings on the underside and/or on the side surfaces, wherein a fluid can be conducted out of the plurality of fluid openings and/or a fluid can be conducted away into the plurality of fluid openings.

The method for the production of a molded concrete block comprises the following steps: filling a mold cavity with a concrete mixture; compacting the concrete mixture by means of a pressure piece that is lowered, engages into the mold cavity, and presses down onto the concrete mixture; conducting a fluid out of fluid openings in the pressure piece onto the concrete mixture or conducting a fluid away out of the concrete mixture, into fluid openings in the pressure piece; lifting the pressure piece off from the compacted concrete mixture.

The pressure piece that is lowered into the mold cavity, also referred to as a mold chamber, for compacting the concrete mixture, and engages into this cavity, is expanded to include a further function. It conducts a fluid, in other words a liquid or a gas, onto the concrete mixture or away out of it. The fluid that is conducted out of the plurality of the fluid openings or conducted away into the plurality of fluid openings is given off from the fluid openings or drawn into them, respectively, when the pressure piece is lowered and lies on the concrete mixture. Introduction and conducting away advantageously take place at the beginning, during or at the end of the compaction step, when the concrete mixture is in the mold cavity, and before unmolding or de-molding, in other words release of the concrete mixture that has solidified to form blocks from the mold. Alternatively, the fluid can also be conducted onto the concrete mixture that was compacted to form a block when it has already been de-molded, before or when the pressure piece is lifted off.

The fluid that is conducted through the fluid openings on the underside of the pressure piece is conducted to the surface of the concrete mixture on which the pressure piece lies. In this way, there is further freedom of design for the molded concrete block, which goes beyond the conventional compaction process and the selection of the concrete mixture. It is advantageous that in this way, the molded concrete block can be colored or other properties of the molded concrete block can be changed, so that the molded concrete block can be provided with additional functions. For example, an impregnation that is accompanied by a hydrophobic surface or an illuminant can be applied during the forming and/or unmolding process. In one embodiment, the apparatus is configured so as to introduce tints or liquid concrete mixture additives, in particular so as to change the surface composition of the block. Introduction of the fluid furthermore offers the advantage of varying the design and/or properties of the blocks by means of a variation in the introduction during the production process, without it being necessary to modify the apparatus. In other words: The block design can be changed after every cycle, with regard to color, color progression or detailed surface structure. This results in greater block product variety in spite of using the same molding tool and the same concrete mixture. Of course this also means greater flexibility.

The fluid is a liquid or a gas. By means of introduction of a gas, for example compressed air, between the pressure piece and the molded block when the pressure piece is lifted up, the risk of surface damage to the block is reduced, and the speed of the rising pressure piece can be increased. The application of compressed air is an aid during unmolding, because it allows better and faster unmolding, and makes increased product quality and faster cycle times possible.

In the embodiments described above, introducing or conducting away the fluid usually takes place by means of the fluid openings on the underside. By means of fluid openings on the side surfaces, which are provided alternatively or in addition, fluid introduced between the pressure piece and the mold cavity wall can achieve a reduction in friction during the compaction step. In this case, the fluid on the pressure piece flanks is a lubricant or a lubrication oil, and brings about minimization of wear between the pressure piece and the mold cavity walls. Compressed air from the fluid openings on the side surfaces can facilitate release of the pressure pieces when the blocks have not been unmolded yet.

By means of the engaged pressure piece, the fluid can be conducted away out of the concrete mixture into the fluid openings, so that the moisture of the concrete mixture in the mold cavity can be reduced and, in particular, liquid on the surface can be suctioned away. As a result, a moister and therefore more easily fillable concrete mixture, in particular decorative concrete, can be used, from which moisture is extracted by the pressure piece after it has been filled into the mold.

The advantages described above are also accompanied by higher cycle numbers and service lifetimes.

In one embodiment, the upper mold part comprises at least one fluid reservoir in the pressure piece, which comprises a fluid connector on the top side of the pressure piece. The plurality of the fluid openings extend to the fluid reservoir, so that the fluid can be passed through the fluid openings from the fluid reservoir and vice versa. Supply of the pressure piece with the fluid, or its removal, takes place by way of the fluid connector. The fluid reservoir distributes the fluid to the fluid openings or, alternatively, collects the fluid that has been drawn in, before it is transported away by way of the fluid connector. In addition, the weight of the pressure piece is reduced by means of the hollow fluid reservoir.

The fluid openings can be configured as holes in the underside and/or the side surfaces. The holes can extend straight from the reservoir to the underside or to the side surfaces, respectively. Because of their usually small diameter, they can also be referred to as “pore channels.” The fluid openings are arranged in a raster shape, in other words in a regular pattern, or irregularly on the underside of the pressure piece. On the side surfaces, as well, the arrangement can be regular or irregular. There are multiple degrees of freedom in the design of the fluid openings. For example, they can be configured to be round or ellipsoid or rectangular.

Alternatively, a porous layer can form the plurality of the fluid openings. The porous layer has small cavities that stand in connection to one another, as in a sponge, through which the fluid can flow. Such a porous layer can be configured, in one embodiment, by means of particles that are connected to one another, between which the cavities for the fluid streaming through extend.

The embodiments of pressure pieces described above can be produced additively, for example by means of 3D printing. This allows a more free design of the pressure piece geometry than in the case of conventional production. In this way, a hollow support structure can also be introduced into the pressure pieces, and their pressure surface can be configured to be holey or porous.

In one embodiment, the apparatus is configured so as to conduct the fluid, in a cycled manner, out of the plurality of fluid openings, in particular into the mold cavity, or to conduct it away out of the mold cavity into the plurality of fluid openings, so that conducting or conducting away only takes place when the pressure piece is lowered onto the concrete mixture and advantageously engages into the mold cavity. By means of the cycled operation, the fluid is conducted onto the concrete mixture or conducted away from the concrete mixture in the mold cavity as a function of the cycle or time, when the pressure piece has been lowered and rests on the concrete mixture.

In the method for the production of a molded concrete part, the introduction or conducting away of the fluid takes place when the pressure piece is resting on the concrete mixture. It is advantageous if this step takes place, in a cycled manner, during the phase in which the pressure piece lies on the concrete mixture. It is advantageous if the concrete mixture is in the mold cavity during this step, so that the step can take place in connection with compaction.

In one embodiment, the fluid can be conducted onto the concrete mixture so as to color the concrete mixture and/or change its surface. This step can be carried out multiple times, so that different fluids are introduced, one after the other. Spatial differentiation is also possible, so that one fluid is conducted onto one or more regions on the surface of the concrete mixture, and a further fluid is conducted onto a different or several different regions of the surface of the concrete mixture.

In an alternative embodiment, the fluid is introduced as a lubricant between lateral mold cavity walls and side surfaces that extend between the top side and underside of the pressure piece. In one embodiment, not only is a fluid conducted into the concrete mixture, but also a further fluid is conducted between the lateral mold cavity walls and the pressure piece, as a lubricant.

In one embodiment, compressed air is introduced between the pressure piece and the concrete mixture when the former is raised, in order to thereby support the release process of the pressure piece from the block and prevent the surface from being torn up.

In one embodiment, liquid is suctioned off from the concrete mixture, so as to thereby reduce the degree of moisture of the concrete mixture and remove liquid that is standing on the surface.

Of course, different steps of introduction or conducting away can also be combined in the method, and the pressure piece can be configured in such a manner that different fluids are introduced or conducted away using the same pressure piece. Such a pressure piece can have one or more fluid reservoirs. For example, liquid can first be suctioned away from the concrete mixture, and then a color and then an impregnation can be applied. A further example provides for applying colors first and then pressing compressed air between the block and the pressure piece.

In the following, some exemplary embodiments are explained in greater detail, using the drawing. The figures show:

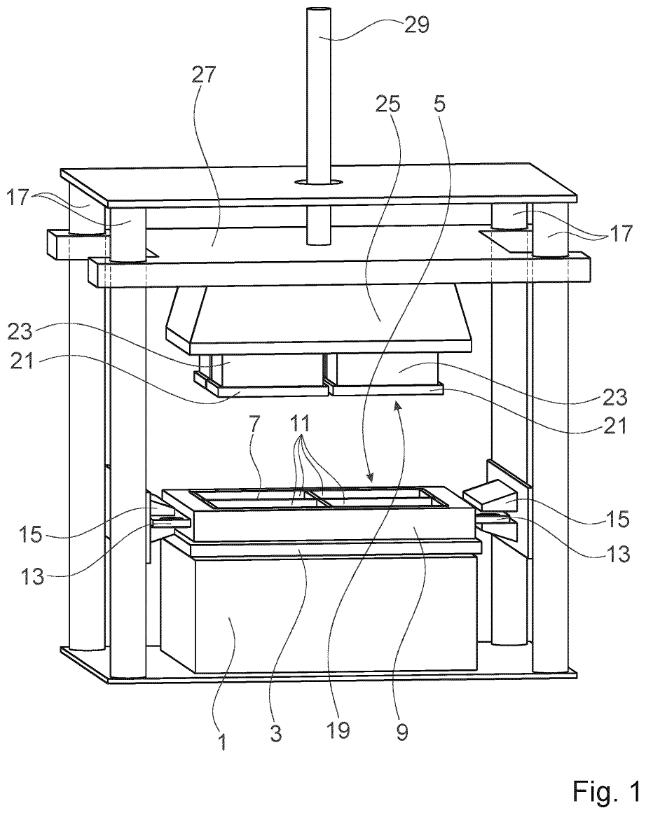

FIG. 1 a perspective side view of an exemplary embodiment of an apparatus for the production of molded concrete blocks,

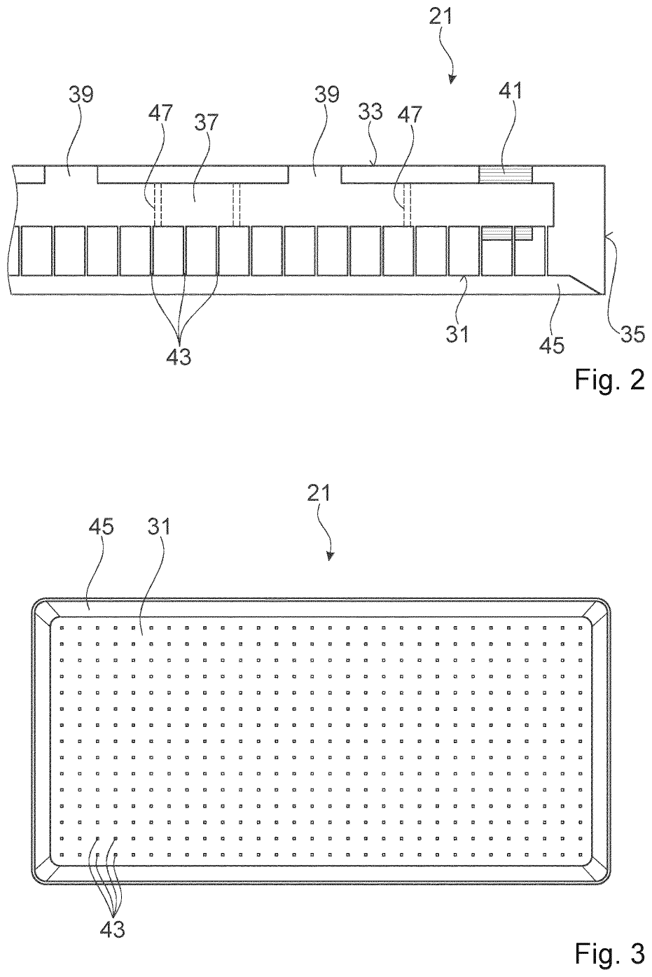

FIG. 2 an exemplary embodiment of a pressure piece in a schematic sectional view,

FIG. 3 an exemplary embodiment of a pressure piece from below,

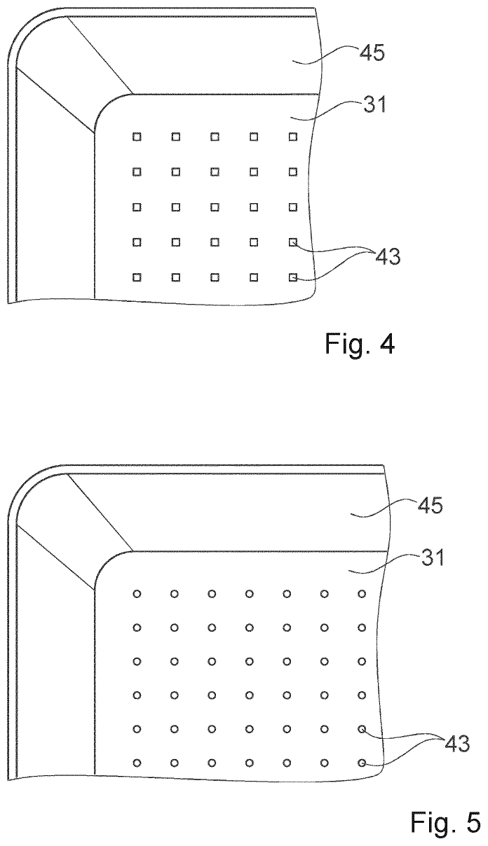

FIG. 4 a region of an exemplary embodiment of a pressure piece from below,

FIG. 5 a region of a further exemplary embodiment of a pressure piece from below,

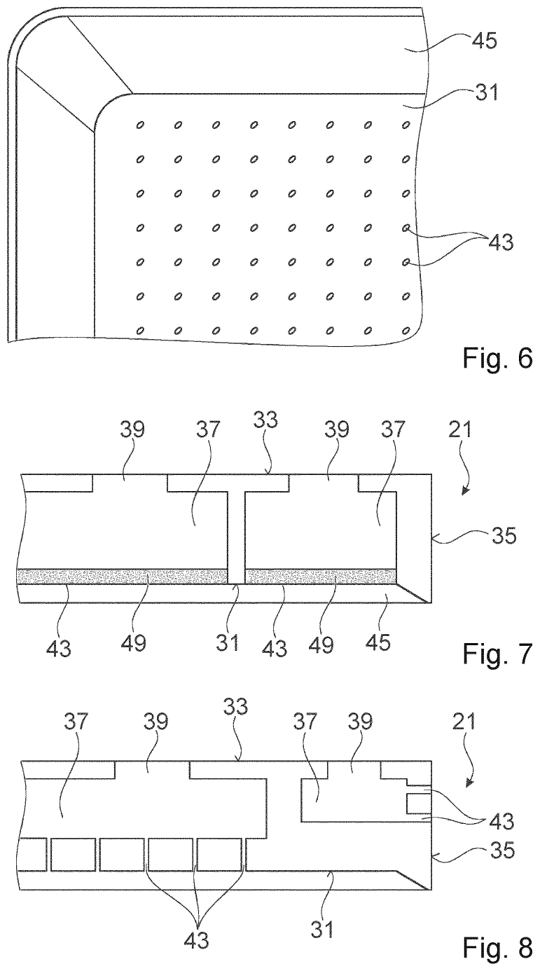

FIG. 6 a region of a further exemplary embodiment of a pressure piece from below,

FIG. 7 a further exemplary embodiment of a pressure piece, in a schematic sectional view, and

FIG. 8 a further exemplary embodiment of a pressure piece in a schematic sectional view.

In the figures, components that are the same or functionally equivalent are provided with the same reference symbols.

Making reference to FIG. 1, a first exemplary embodiment of an apparatus for the production of molded concrete blocks will be explained in the following.

The apparatus is shown in a perspective side view and has a vibration table 1, in a manner usual in the art, on the surface of which table a production board 3 is situated. A lower mold part 5 is arranged on the production board 3, which part has an interchangeable insert 7 with recesses that are surrounded by a frame 9, wherein the insert 7 is interchangeable in the frame 9. The recesses surrounded by the frame 9 form mold cavities 11. On two opposite sides, the frame 9 has holding struts 13, which create a connection between the frame 9 and a holder 15, in each instance. In an exemplary embodiment, the holding struts 13 can also be part of the holders 15. The two holders 15 are arranged on four guide columns 17, which are arranged, in a manner usual in the art, in the region of the corners of the lower mold part 5, and surround the region outside of the vibrating table 1. The upper mold part 19 is arranged opposite to the cavities 11; it has multiple plate-shaped pressure pieces 21 that approximately correspond, in terms of their dimensions, to the mold cavities 11. The pressure pieces 21 are connected to a top-load device 25, by way of pressure punches 23, which device, in turn, stands in connection with an upper top-load part 27, on the side facing away from the upper mold part 19, which part is guided on the guide columns 17 and can be activated with a hydraulic press, by way of a punch 29.

During concrete block production, the mold cavities 11 are filled with a concrete mixture. The concrete mixture is compacted by introduction of the pressure pieces 21, and renewed filling results in a layered concrete mixture. After filling, the main compaction of the layered concrete mixture takes place. During this process, the pressure pieces 21 enter into the mold cavities 11, and the concrete mixture is compacted with the help of pressure from above and shock vibration of the moving vibrating table 1, and thereby formed into blocks. Subsequently, the mold is raised to unmold the block layer. Then the pressure pieces 21 are lifted off the blocks.

The pressure pieces 21 are configured in such a manner that they can introduce a fluid, in other words a liquid or a gas, into the mold cavities 11 or conduct it out of them.

FIG. 2 schematically shows an exemplary embodiment of a pressure piece 21 in a sectional representation from the side. The pressure piece 21, also referred to as a pressure plate, has characteristics in layers that are arranged one on top of the other, having different functionality.

The pressure piece 21 comprises an underside 31 that faces the mold cavity 11 (not shown in FIG. 2) and an opposite top side 33, as well as side surfaces 35 that run around the edge side, in between. A fluid reservoir 37 is arranged in the interior of the pressure piece 21, to which at least one fluid connector 39 extends on the top side 33. The fluid reservoir 37 is configured as a cavity in the interior of the pressure piece 21. Optionally, support structures 47 can be provided, for example struts on the reservoir walls and/or column-shaped supports in the reservoir interior. A honeycomb structure is also conceivable. The support structures 47 are shown with broken lines in FIG. 2. Optionally, structures are provided that support the distribution of the fluid in the fluid reservoir 37. The fluid reservoir 37 in the pressure piece 21 is a layer for stabilization and fluid distribution.

The top side 33 is the installation side of the pressure piece 21, at which it is attached to the pressure punch 23 (not shown in FIG. 2). It can have threads and bores as fastening means 41, for example so as to fasten it to the pressure punch 23 by means of screw connections. The fluid connector 39 can be configured as a through-bore to the fluid reservoir 37. By way of the fluid connector 39, a fluid can be introduced into the fluid reservoir 37 or suctioned out of it. By way of the installation side, also referred to as the screw-on side, supply of the fluid reservoir 37 with fluids takes place, or, respectively, their removal from the fluid reservoir 37, for example by means of a pump apparatus or suction apparatus (not shown in FIG. 2), which can be a component of the apparatus. The installation side is a layer for fixation and for supplying and/or conducting away fluid.

The underside 31 is the mirror of the pressure piece 21, with which pressure is exerted on the concrete mixture in the mold cavity 11. In this exemplary embodiment, it has a circumferential bevel 45. The underside is a layer that forms the block surface. A plurality of fluid openings 43 on the underside 31 extend all the way to the fluid reservoir 37. In this exemplary embodiment, the fluid openings 43 are arranged in a regular pattern. The perforated layer between fluid reservoir 37 and underside 31 has holes having a slight diameter, which can also be referred to as pore channels. The layer having the fluid openings 43 configured as holes can have a thickness, for example, of approximately 9 mm. Excess pressure or partial vacuum, in particular caused by the fluid that is introduced or suctioned off, at the fluid connector 39 brings about exit of the fluid from the fluid openings 43 or, respectively, drawing in of the fluid from the mold cavity 11 into the fluid openings 43. The perforated, permeable layer with the fluid openings 43 is a functional layer, by means of which the fluid is introduced into the mold cavities 11 or conducted away out of them.

In operation, the fluid is filled in through the fluid connector 39 that is configured as a passage bore, is distributed in the fluid reservoir 37 with its filling and support structure, is conveyed through the fluid openings 43 to the underside 31 that serves as a mirror side, and exits from the fluid openings 43. Alternatively, in operation, drawing in of the fluids can take place through the fluid openings 43. Introduction and removal of the fluid into and from the fluid reservoir 37 takes place, for example, by means of a pump apparatus or a suction apparatus, which is advantageously part of the apparatus.

FIG. 3 shows the underside 31 of the pressure piece 21 from FIG. 2. It is the mirror side that rests on the concrete mixture. The fluid openings 43 are arranged on the underside 31 in raster shape, in other words in a regular pattern, and extend up to the bevel 45. In an alternative embodiment, they can also be spaced farther apart from the bevel 45 than from other fluid openings 43. In this exemplary embodiment, placement of the fluid openings 43 on the smooth mirror surface takes place in a rectangular pattern, as a regularly arranged structure. In the case of a greater number of fluid openings 43, the distances between the fluid openings 43 would be less. In the case of a lesser number of fluid openings 43, the distance between the fluid openings 43 would be greater. The placement of the fluid openings 43 can depend on the fluid used, in particular whether it is a liquid or a gas, and can be adapted to user-specific requirements.

In an alternative exemplary embodiment, the fluid openings 43 can be arranged on the underside 31 irregularly, similar to a random distribution or the like, instead of in a regular pattern.

FIGS. 4 to 6 show a detail of the undersides 31, in other words the mirror sides, of different exemplary embodiments of a pressure piece 21, which differ with regard to the fluid opening shape, in particular its bore cross-section. FIG. 4 shows fluid openings 43 having a rectangular contour. FIG. 5 shows fluid openings 43 having a round contour. FIG. 6 shows fluid openings 43 having an ellipsoid contour.

FIG. 7 schematically shows a further exemplary embodiment of a pressure piece 21 in a sectional representation.

The pressure piece 21 has more than one fluid reservoir 37 having a fluid connector 39 on the top side 33. A plurality of fluid openings 43 on the underside 31 extends to the fluid reservoir 37. The fluid openings 43 are configured in a porous layer 49 on the underside 31. The porous layer 49 has small cavities that are connected to one another as in the case of a sponge, through which the fluid can flow. Such a porous layer 49 can also be formed by particles that are connected to one another, between which the cavities extend. It can be formed by means of sintering, for example.

By means of providing multiple fluid reservoirs 37, different fluids can be introduced into the concrete mixture, in a spatially differentiated manner.

The exemplary embodiments described above are configured so that a fluid is dispensed or taken up during the production process, by way of the fluid openings 43.

During production of a molded concrete block, the mold cavity 11 is filled with a concrete mixture. The concrete mixture is compacted by means of the lowered pressure piece 21, which engages into the mold cavity 11 and presses down on the concrete mixture. Optionally, another concrete mixture can be filled in as a decorative concrete. The concrete mixture is compacted by means of the pressure piece 21 that engages into the mold cavity 11 and presses down on the concrete mixture. Compaction is supported by vibration. Then unmolding and raising of the pressure piece 21 off the compacted concrete mixture that forms the block take place. During production of the molded concrete block, a fluid is conducted out of fluid openings 33 in the pressure piece 21, into the mold cavity 11, while the pressure piece 21 is engaged, and/or a fluid is conducted away out of the concrete mixture into the fluid openings 43 while the pressure piece 21 is engaged. Introduction can also take place when the block has already been unmolded, by means of the pressure piece 21 that is still resting in place.

The introduction of fluid or conducting away of fluid into or out of the mold cavity 11, respectively, takes place as a function of time, in a cycled manner, so that it advantageously takes place when the pressure piece 21 engages into the mold cavity and lies on the concrete mixture, so that the introduction of fluid or conducting away of fluid takes place onto or out of the concrete mixture, respectively.

During compaction, it is advantageous that a liquid fluid can be applied to the surface of the concrete mixture. Such a fluid can be a pigment, a concrete mixture additive for forming a functional surface, for example an impregnation, or something else.

The introduction of colors allows the production of blocks having contrast-rich colors. The surface of the blocks can be colored over the full area, uniformly, or with a color mix, also referred to as a colormix. The latter can be achieved if different colors are introduced one after the other. In the case of a pressure piece 21 having multiple fluid reservoirs 37, each of which are only connected to some of the fluid openings 43, the fluid can be applied to the concrete mixture with spatial differentiation, so that, for example, one color is applied only to certain regions of the block surface, or different colors are applied to different regions. In this way, blocks can also be produced with color mix. The colors can be positioned individually. In an exemplary embodiment, the positioning of color dots on the block surface can take place randomly, in that during production, the color composition and/or the amount of color in the fluid reservoir or reservoirs 37 is varied during production.

The use of a pressure piece 21 for introduction of one or more fluids offers the user greater flexibility and a greater product variety of blocks that are produced using the same molding tool and the same concrete mixture mix. The block design can be changed, in a simple manner, by means of the selection of the fluid, even in every production cycle, in particular with regard to color, color progression and surface microstructure. This reduces the time required for the production of different block designs, since time-consuming retooling of the apparatus for different designs is no longer necessary. The block can additionally or alternatively be configured with an additional functional surface, for example an impregnation, in other words a hydrophobic surface, or a luminescent surface by means of application of a luminescent material.

In another exemplary embodiment of production, compressed air is conducted onto the concrete mixture through the fluid openings 43, so as to make faster unmolding possible. Compressed air also reduces the risk of surface damage when raising the pressure piece 21, so that the surface of the block is closed and no tearing of the block surface takes place. This is accompanied by greater production quality and faster cycle times during production.

Of course the introduction of a liquid fluid, whether it is for coloring or for the formation of a functional surface, can also be followed by the introduction of compressed air, so as to combine the advantages mentioned above. The compressed air furthermore cleans the fluid openings 43 during every production step, so that the risk that they will plug up during production is reduced. This method can be carried out using a pressure piece 21 that has only one fluid reservoir 37 or has multiple fluid reservoirs 37.

In another exemplary embodiment, fluid is drawn in from the concrete mixture through the fluid openings 43 and conducted away. This method of procedure, in the case of particularly damp concrete mixture mixes, during the production process, allows excess liquid, in particular water, to be suctioned away from the block surface. This method of procedure can be carried out using a pressure piece 21 that has only one fluid reservoir 37 or has multiple fluid reservoirs 37. Conducting the liquid away can take place before introduction of a further fluid, for example for coloring.

FIG. 8 schematically shows a further exemplary embodiment of a pressure piece 21 in a sectional representation. In this exemplary embodiment, the pressure piece 21 has two separate fluid reservoirs 37, each having fluid connectors 39. One is arranged circumferentially and adjacent to the side surface 35. Fluid openings 43, which are configured as channels, extend from the fluid reservoir 37 to the side surfaces 35. A further fluid reservoir 37 is arranged in the central region of the pressure piece 21. Fluid openings 43, which are configured as channels, extend from the underside 31 to this fluid reservoir 37.

The provision of two fluid reservoirs allows the use of two different fluids. Fluid configured as a lubricant is dispensed through the fluid openings 43 on the side surfaces 35, so as to reduce the friction between the pressure piece 21 and the walls of the mold cavity 11 (not shown in FIG. 8). By way of the fluid openings on the underside 31, color and/or compressed air, for example, can be dispensed, and/or liquid can be suctioned away.

It is also possible to provided fluid openings merely on the side surfaces in an exemplary embodiment, so as to reduce friction during compaction.

The characteristics indicated above and in the claims, as well as those that can be derived from the figures, can be advantageously implemented both individually and in different combinations. The invention is not restricted to the exemplary embodiments described, but rather can be modified in different ways, within the scope of the ability of a person skilled in the art.

### REFERENCE SIGN LIST

1 vibrating table
3 production board
5 lower mold part
7 insert
9 frame
11 mold cavity
13 holding strut
15 holder
17 guide column
19 upper mold part
21 pressure piece
23 pressure punch
25 top-load device
27 upper top-load part
29 punch
31 underside
33 top side
35 side surface
37 fluid reservoir
39 fluid connector
41 fastening means
43 fluid opening
45 bevel
47 support structure
49 porous layer

1. An apparatus for the production of molded concrete blocks, having
a lower mold part (5), in which at least one mold cavity (11) is formed, and
an upper mold part (19) comprising at least one pressure piece (21) having an underside (31) that faces the mold cavity (11), and a top side (33) that faces away from the mold cavity (11), as well as side surfaces (35), wherein the pressure piece (21) can be lowered in such a manner that it the pressure piece (21) engages into the mold cavity (11),
and wherein the pressure piece (21) has a plurality of fluid openings (43) on the underside (31) and/or on the side surfaces (35), and wherein a fluid can be conducted out of the plurality of fluid openings (43) or conducted away into the plurality of fluid openings (43).

2. The apparatus according to claim 1, wherein when the pressure piece (21) is lowered, the fluid can be conducted out of the plurality of fluid openings (43) into the mold cavity (11), or, when the pressure piece (21) is lowered, the fluid can be conducted out of the mold cavity (11) by the plurality of fluid openings (43).

3. The apparatus according to claim 1, wherein the upper mold part (19) comprises at least one fluid reservoir (37) in the pressure piece (21), which comprises a fluid connector (39) on the top side (33) of the pressure piece (21), and wherein the plurality of the liquid openings (43) extend up to the fluid reservoir (37).

4. The apparatus according to claim 1,
wherein the fluid openings (43) are configured as holes in the underside (31) and/or in the side surfaces (35).

5. The apparatus according to claim 1,
wherein the fluid openings (43) are arranged on the underside (31) of the pressure piece (21) in a raster pattern or irregularly.

6. The apparatus according to claim 1,
wherein the fluid openings (43) are configured to be round or ellipsoid or rectangular.

7. The apparatus according to claim 1,
wherein a porous layer (49) forms the plurality of the fluid openings (43).

8. The apparatus according to claim 1,
which is configured to conduct the fluid out of the plurality of the fluid openings (43) in a cycled manner, or to conduct the fluid away out of the mold cavity (11) into the plurality of the fluid openings (43).

9. The apparatus according to claim 3,
which is configured to conduct the fluid into the pressure piece (21) by way of the fluid connector (39) or to suction the fluid out of the pressure piece (21) by way of the fluid connector (39).

10. The apparatus according to claim 1,
which is configured to conduct compressed air, paint, concrete mixture additive or lubricant out of the plurality of the fluid openings (43), or is configured to conduct fluid away out of the mold cavity (21).

11. A method for the production of a molded concrete block comprising:
filling a mold cavity (11) with a concrete mixture,
compacting the concrete mixture by means of a pressure piece (21), which is lowered, engages into the mold cavity (11), and presses down on the concrete mixture,
conducting a fluid from fluid openings (43) in the pressure piece (21) onto the concrete mixture, or conducting a fluid away out of the concrete mixture, into fluid openings (43) in the pressure piece (21), and
lifting the pressure piece (21) off the compacted concrete mixture.

12. The method according to claim 11, wherein when conducting or conducting away the fluid, the concrete mixture is in the mold cavity (11).

13. The method according to claim 11, wherein the fluid colors the concrete mixture or changes its top side composition or changes its chemical or physical property.

14. The method according to claim 11, wherein the fluid is conducted, as a lubricant, between lateral mold cavity walls and side surfaces (35) of the pressure piece (21).

15. The method according to claim 11, wherein compressed air is conducted between the pressure piece (21) and the concrete mixture.

16. The method according to claim 11, wherein fluid is suctioned away out of the concrete mixture.

17. The method according to claim 11,
wherein the fluid is conducted out of the fluid openings (43), in a cycled manner, or conducted away into the fluid openings (43).
